(19) United States
(12) Patent Application Publication
(10) Pub. No.: US 2011/0102353 A1
(43) Pub. Date: May 5, 2011

(54) TOUCH PANEL APPARATUS AND A METHOD FOR DETECTING A CONTACT POSITION ON THE SAME

(75) Inventors: Bom-Yun Kim, Yongin-si (KR); Duck-Young Jung, Yongin-si (KR); Sang-Jin Lee, Yongin-si (KR); Chul-Yong Joung, Yongin-si (KR); Jin-Woo Chung, Yongin-si (KR); Young-Ho Shin, Yongin-si (KR); Bang-Won Lee, Yongin-si (KR)

(73) Assignee: ATLAB INC., Yongin-si (KR)

(21) Appl. No.: 12/993,157

(22) PCT Filed: Mar. 23, 2009
(86) PCT No.: PCT/KR2009/001473

§ 371 Date: Nov. 17, 2010

(30) Foreign Application Priority Data
Jun. 2, 2008 (KR) 10-2008-0051800

(51) Int. Cl. G06F 3/041

(52) U.S. Cl. 345/173

(57) ABSTRACT

A touch panel device and a method for detecting a contact position are provided. The touch panel device includes a touch panel including a first touch pattern, the first touch pattern having a plurality of first touch pads connected in series; and a touch sensor for applying a clock signal to one terminal of the first touch pattern, receiving a first delayed clock signal from the other terminal of the first touch pattern, and generating contact position data corresponding to a contact position of an object using a difference in delay time between the clock signal and the first delayed clock signal. Thus, since the plurality of touch pads are connected in series, the contact position of the entire touch panel can be sensed with only one touch sensor, and the touch pad has a greater area than the connection line for a distinguished difference in resistance between the touch pad and the connection line, such that the contact position can be accurately detected.

### TECHNICAL FIELD

The present invention relates to a touch panel device, and more particularly, to a touch panel device with a reduced number of touch sensors, and a method for detecting a contact position on the touch panel.

### BACKGROUND ART

An indium tin oxide (ITO) film is widely used as a transparent electrode (film) for display devices, such as liquid crystal displays. The ITO has been applied as an electrode material to devices from several fields, such as liquid crystal display (LCD) devices, organic light emitting diodes, solar cells, plasma displays, E-Papers, and the like because of its high transparency and low sheet resistance as a thin transparent conductive oxide film, and easy patterning. It has also been applied to reduce electro-magnetic interference for a cathode ray tube (CRT) monitor, and ITO ink.

A touch panel device using ITO is described in Korean Patent Publication No. 10-2007-0112750.

FIG. 1 illustrates a configuration of a conventional touch panel device using ITO. The touch panel device includes an ITO film 10 and a touch sensor unit 20. The ITO film 10 has pairs of rod-like touch pads 11 and 12.

One side of the rod-like touch pads 11 and other side of the rod-like touch pads 12 are connected to the touch sensor unit 20, respectively. Each touch pad pair delays an input clock signal CLK according to resistance varying with a contact position of an object and outputs delayed clock signals ts1_sig1 and ts1_sig2. The touch sensor unit 20 receives the delayed clock signals ts1_sig1 and ts1_sig2 from the pair of rod-like touch pads 11 and 12 and detects delay times of the delayed clock signals ts1_sig1 and ts1_sig2 to obtain the contact position of the object.

For example, when an object (e.g., a finger) is brought into contact with a contact surface A of the rod-like touch pads 11 and 12, the rod-like touch pad 11 has a longer distance from the clock signal CLK to the contact point A, and the rod-like touch pad 12 has a shorter distance from the clock signal CLK to the contact point A. Accordingly, resistance between the touch sensor unit 20 to the contact point A of the rod-like touch pad 11 becomes relatively smaller than that of the rod-like touch pad 12, resulting in a longer delay time, and the resistance of the rod-like touch pad 12 becomes relatively smaller than that of the rod-like touch pad 11, resulting in a shorter delay time. In this case, the touch sensor unit 20 detects the delay times of the rod-like touch pads 11 and 12 in the pair, calculates an average of coordinates corresponding to the detected delay times, and determines Y-axis contact positions of the rod-like touch pads 11 and 12.

Numbers are sequentially given to the rod-like touch pad pairs formed on the ITO film. A coordinate corresponding to numbers of the rod-like touch pads 11 and 12 brought into contact with the object is determined as an X-axis position of the object.

Here, the capacitance caused by the object may also cause the delay time. As a result, the clock signal CLK may be delayed by the resistance of the rod-like touch pad 11, as well as the capacitance of the object.

Additionally, conductors for connecting the rod-like touch pads 11 and 12 to the touch sensor unit 20 may affect the delay time of the clock signal CLK. To reduce the influence of the conductors, it is desirable that lengths of the conductors for the delayed clock signals ts1_sig1 and ts1_sig2 from the rod-like touch pads 11 and 12 to the touch sensor unit 20 are the same.

FIG. 2 illustrates an example of a touch sensor unit using pairs of touch pads in FIG. 1. The touch sensor unit 20 comprises at least a touch sensor. And the touch sensor includes a clock signal generator 30, first and second signal amplifiers 31 and 32, first and second signal comparators 41 and 42, and a contact position data generator 51, respectively.

The touch sensor of FIG. 2 will be described with reference to FIG. 1.

The clock signal generator 30 generates the clock signal CLK and applies it to the pairs of rod-like touch pads and to the first and second signal comparators 41 and 42.

The first signal amplifier 31 receives the first delayed clock signal ts1_sig1, which is obtained as the clock signal CLK passes through the rod-like touch pad 11, and amplifies and outputs the first delayed clock signal ts1_sig1.

The first signal comparator 41 compares the first amplified delayed clock signal ts1_sig1 with the clock signal CLK and generates a first signal sig1 corresponding to a delay time.

The second signal amplifier 32 receives the second delayed clock signal is ts1_sig2, which is obtained as the clock signal CLK passes through the rod-like touch pad 12, and amplifies and outputs the second delayed clock signal ts1_sig2.

The second signal comparator 42 compares the second amplified delayed clock signal ts1_sig2 with the clock signal CLK, and generates a second signal sig2 corresponding to a delay time.

The contact position data generator 51 receives the first and second signals sig1 and sig2, obtains coordinate values corresponding to the first and second signals sig1 and sig2, and averages the obtained coordinate values to obtain the Y-axis coordinate value. The contact position data generator 51 also obtains a coordinate corresponding to the number of the rod-like touch pad pair brought into contact with the object among the sequentially given numbers of the rod-like touch pad pairs, as the X-axis coordinate value. The contact position data generator 51 outputs contact position data TS_OUT corresponding to the obtained Y- and X-axis coordinate values.

When one of the touch pad pairs with which the object is brought into contact is affected by noise, the conventional touch panel device does not output an exact contact position of the object. Also, since each pair of rod-like touch pads 11 and 12 has resistance varying linearly with the contact position of the object, it is also highly susceptible to noise.

An increasing number of touch pad pairs for a high-resolution touch panel causes a need for a plurality of touch sensors, which increases the number of a touch sensor unit. In addition, even when one touch sensor is used to sequentially check a plurality of touch pad pairs and obtain a contact position of an object for the purpose of reducing the number of a touch sensor unit, a contact-position detection time increases with the number of touch pad pairs added for high resolution.

### DISCLOSURE

### Technical Problem

The present invention provides a touch panel device capable of sensing contact of an object using only one touch sensor by having a touch pattern in which a plurality of touch pads are connected in series by connection lines.

The present invention also provides a method for detecting a contact position on a touch panel device.

### Technical Solution

The present invention discloses a touch panel device including: a touch panel including a first touch pattern, the first touch pattern having a plurality of first touch pads connected in series; and a touch sensor for applying a clock signal to one terminal of the first touch pattern, receiving a first delayed clock signal from the other terminal of the first touch pattern, and generating contact position data corresponding to a contact position of an object using a difference in delay time between the clock signal and the first delayed clock signal.

The touch sensor may include a clock generator for generating the clock signal and outputting it to one terminal of the first touch pattern; a delayed-signal detector for sensing a level of the first delayed clock signal from the other terminal of the first touch pattern and outputting a first pulse clock signal; a comparator for calculating the difference in delay time between the clock signal and the first pulse clock signal and outputting a first delay time; and a contact position data generator for calculating a contact position corresponding to the first delay time and outputting the contact position data.

The touch sensor may include a clock generator for generating the clock signal and alternately outputting it to one terminal and the other terminal of the first touch pattern; a delayed-signal detector for sensing a level of the first delayed clock signal output from the other terminal of the first touch pattern as the clock signal is delayed and a level of the second delayed clock signal output from one terminal of the first touch pattern, and outputting the first and second pulse clock signals; a comparator for calculating a difference in delay time between the clock signal and the first pulse clock signal and outputting a first delay time, and calculating a difference in delay time between the clock signal and the second pulse clock signal and outputting a second delay time; and a contact position data generator for calculating contact positions corresponding to the first and second delay times and outputting the contact position data.

The contact position data generator may generate the contact position data using a difference between the first and second delay times.

The contact position data generator may generate the contact position data using a ratio of the first and second delay times.

The contact position data generator may calculate a first contact position corresponding to the first delay time and a second contact position corresponding to the second delay time, obtain a central position between the calculated contact positions, and generate a contact position data from the central position.

The touch panel may include a first ITO film, in which the plurality of first touch pads of the first touch pattern are uniformly distributed on one entire surface of the first ITO film.

The touch panel may be disposed so that ones of the plurality of first touch pads of the first touch pattern are not simultaneously brought into contact with an object.

The touch panel may further comprise at least a second touch pattern.

The touch panel may further include at least the second touch pattern comprising a plurality of second touch pads each disposed between the plurality of first touch pads of the first touch pattern on the same surface of the first ITO film, and a plurality of second connection lines for connecting the plurality of second touch pads in series.

The touch panel may further include at least the second touch pattern comprising a plurality of second touch pads each disposed between the plurality of first touch pads of the first touch pattern on the same surface of the first ITO film, and a plurality of second connection lines for connecting the plurality of second touch pads in series.

The touch panel may further include at least a second touch pattern comprising a plurality of second touch pads uniformly distributed on the entire other surface of the first ITO film, and a plurality of second connection lines for connecting the plurality of second touch pads in series.

The touch panel may further include at least a second ITO film, and at least the second touch pattern including a plurality of second touch pads uniformly distributed on one entire surface of the at least second ITO film, and a plurality of second connection lines for connecting the plurality of second touch pads in series.

The touch panel may further include at least a second ITO film, and at least the second touch pattern including a plurality of second touch pads uniformly distributed on the entire other surface of the second ITO film, and a plurality of second connection lines for connecting the plurality of second touch pads in series.

The touch panel may further include an insulating member for insulating the first and second touch patterns not to be short-circuited with each other at crossing points, and the insulating member may be disposed in an edge area of the first ITO film or external to the first ITO film.

The present invention also discloses a method for detecting a contact position on a touch panel device, the method including: disposing a first touch pattern, the first touch pattern having a plurality of first touch pads connected in series; and applying a clock signal to one terminal of the first touch pattern, receiving a first delayed clock signal from the other terminal of the first touch pattern, and generating contact position data corresponding to a contact position of an object using a difference in delay time between the clock signal and the first delayed clock signal.

Disposing a first touch pattern may further include disposing a plurality of first connection lines in order to connect the plurality of first touch pads in series, the plurality of first connection lines being formed by patterning a conductive material in a narrower area than the plurality of first touch pads between the plurality of first touch pads.

Generating contact position data may comprise generating the clock signal and outputting it to one terminal of the first touch pattern; sensing a level of the first delayed clock signal output from the other terminal of the first touch pattern, and outputting a first pulse clock signal; calculating a difference in delay time between the clock signal and the first pulse clock signal and outputting the first delay time; and calculating a contact position corresponding to the first delay time and outputting the contact position data.

The method may further include, by the touch sensor, generating the clock signal and alternately outputting it to one terminal or the other terminal of the first touch pattern; sensing a level of a first delayed clock signal output from the other terminal of the first touch pattern as the clock signal is delay and a level of a second delayed clock signal output from one terminal of the first touch pattern, and outputting first and second pulse clock signals; calculating a difference in delay time between the clock signal and the first pulse clock signal to output a first delay time, and calculating a difference in delay time between the clock signal and the second pulse clock signal to output a second delay time; and calculating a contact position corresponding to the first and second delay times and outputting the contact position data.

### Advantageous Effects

Thus, in the touch panel device and the method for detecting a contact position according to the present invention, since the plurality of touch pads are connected in series to form the touch pattern, the contact position of the entire touch panel can be sensed with only one touch sensor. Furthermore, the touch pad has a greater area than the connection line for a distinguished difference in resistance between the touch pad and the connection line, such that the contact position of the object can be easily sensed even when there is noise. In addition, the touch sensor alternately inputs the clock signal to both terminals of the touch pad in a serial connection, and calculates the contact position of the object using the delay time of the output signal, thereby minimizing the influence of noise. Furthermore, the use of the plurality of touch patterns can increase the resolution of the touch panel.

### DESCRIPTION OF DRAWINGS

FIG. 1 illustrates a configuration of a conventional touch panel device using ITO;

FIG. 2 illustrates an example of a touch sensor unit using pairs of touch pads in FIG. 1;

FIG. 3 illustrates a touch panel device according to a first exemplary embodiment of the present invention;

FIG. 4 is a block diagram for explaining a configuration of a touch sensor of FIG. 3 and a method for detecting a contact position;

FIG. 5 illustrates a touch panel device according to a second exemplary embodiment of the present invention;

FIG. 6 is a block diagram for explaining a configuration of a touch sensor in FIG. 5 and a method for detecting a contact position;

FIG. 7 illustrates a touch panel device according to a third exemplary embodiment of the present invention;

FIG. 8 is a graph showing a delay time depending on a contact position of an object obtained using the touch sensor of FIG. 6;

FIGS. 9 and 10 illustrate a touch pattern disposed on an ITO film according to another exemplary embodiment of the present invention; and

FIGS. 11 and 12 are diagrams for explaining interpolation in the touch panel device according to the present invention.

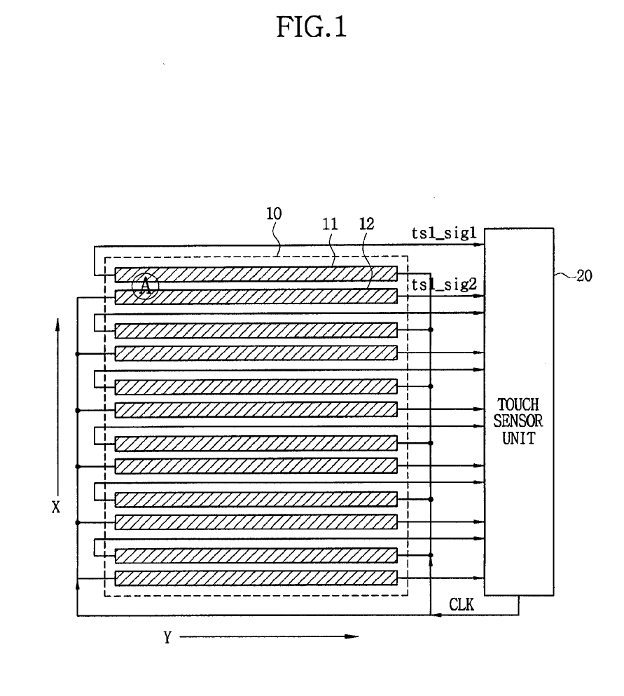

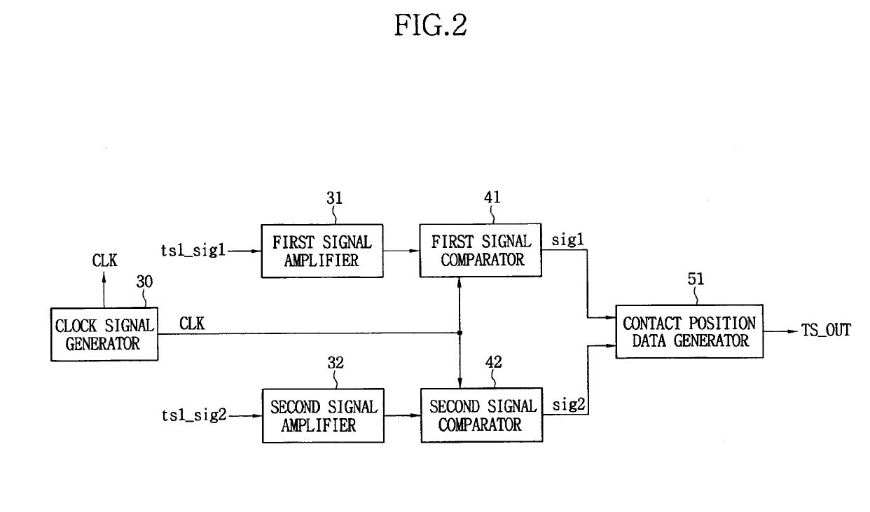

### MODE FOR INVENTION

The invention is described more fully hereinafter with reference to the accompanying drawings, in which exemplary embodiments of the invention are shown.

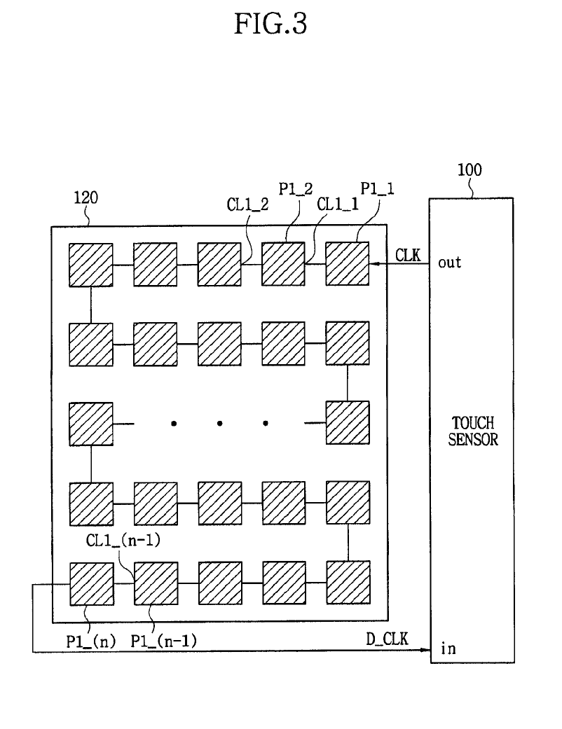

FIG. 3 illustrates a touch panel device according to a first exemplary embodiment of the present invention. The touch panel device includes an indium tin oxide (ITO) film 120 and a touch sensor 100.

In FIG. 3, a touch pattern is formed on one entire surface of the ITO film 120. The touch pattern includes a plurality of touch pads P1_1 to P1_(n) and a plurality of connection lines CL1_1 to CL1_(n−1), each having predetermined resistance. Each of the touch pads P1_1 to P1_(n) is connected in series with adjacent touch pads by corresponding ones of the connection lines CL1_1 to CL1_(n−1). The plurality of connection lines CL1_1 to CL1_(n−1) may be formed of conductors. However, it is assumed herein that the plurality of connection lines CL1_1 to CL1_(n−1) are formed by ITO patterning, like the touch pads P1_1 to P1_(n).

The touch pads P1_1 to P1_(n) and the connection lines CL1_1 to CL1_(n−1) patterned on the film 120 have different sizes to make resistances different. As shown in FIG. 3, the touch pads P1_1 to P1_(n) are wider so that an object can be easily brought into contact with the touch pads, and accordingly have smaller resistance than the narrower connection lines CL1_1 to CL1_(n−1). Since the plurality of touch pads P1_1 to P1_(n) differ in resistance from the plurality of connection lines CL1_1 to CL1_(n−1), the touch pattern of FIG. 3 can be represented as resistance varying non-linearly with a contact position of an object. That is, since the touch pads and the connection lines having different resistances makes the resistance of the touch pattern highly different depending on contact positions, it results in a region for detecting the contact position of the object being divided into predetermined unit regions by the plurality of touch pads P1_1 to P1_(n) and the plurality of connection lines CL1_1 to CL1_(n−1). When the predetermined unit regions are used to detect the contact position of the object, unit regions with which the object is brought into contact can be easily detected even when noise is generated in the touch pattern, although it is difficult to detect the contact position of the object with high resolution. Such a detection of the object is made similar to digital signal differing from analog signal with precision.

For example, when an object (e.g., a finger) having predetermined capacitance is brought into contact with the connection line CL1_1 on the ITO film 120 of FIG. 3, resistance in this case is substantially the same as that when the object is brought into contact with the touch pad P1_2 adjacent to the connection line CL1_1 because the connection lines CL1_1 to CL1_(n−1) have great resistance and the touch pads P1_1 to P1_(n) have small resistance. Since the connection lines CL1_1 to CL1_(n−1) have small areas, contact-induced capacitance is too small to cause contact detection.

The touch sensor 100 comprises a clock output pin out and a clock input pin in. The clock output pin out is connected to the first touch pad P1_1 of the plurality of touch pads P1_1 to P1_(n) connected in series on the touch pattern, and the clock input pin in is connected to the last touch pad P1_(n). The touch sensor 100 generates a clock signal CLK and outputs it to the first touch pad P1_1 via the clock output pin out, and receives a delayed clock signal D_CLK, which is obtained as the clock signal passes through the plurality of touch pads P1_1 to P1_(n), via the clock input pin in. The touch sensor 100 calculates a position of an object brought into contact with the ITO film 120 using the delayed clock signal DCLK received via the clock input pin in, and outputs contact position data TS_OUT.

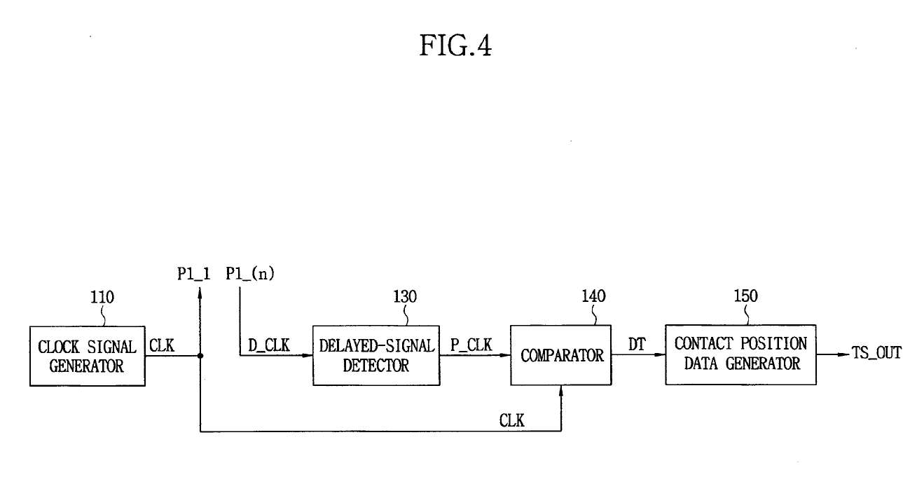

FIG. 4 is a block diagram for explaining a configuration of the touch sensor 100 of FIG. 3 and a method for detecting a contact position. In FIG. 4, the touch sensor 100 comprises a clock signal generator 110, a delayed-signal detector 130, a comparator 140, and a contact position data generator 150.

A configuration of the touch sensor in FIG. 4 will be described with reference to FIG. 3.

The clock signal generator 110 generates the clock signal CLK and outputs it to the clock output pin out.

Since the touch pad P1_1 of the ITO film 120 in FIG. 3 is connected to the clock output pin out as described above, the clock signal CLK input to the touch pad P1_1 is delivered to the clock input pin in via the plurality of touch pads P1_1 to P1_(n). When the clock signal CLK is input to the touch pattern, it is delayed and distorted by the resistance of the plurality of touch pads P1_1 to P1_(n) and the plurality of connection lines CL1_1 to CL1_(n−1), and the capacitance of the object brought into contact with the touch pads P1_1 to P1_(n), resulting in a delayed clock signal D_CLK.

The delayed-signal detector 130 receives the delayed clock signal D_CLK, detects a level of the delayed clock signal D_CLK, and generates a pulse clock signal P_CLK.

The comparator 140 compares the pulse clock signal P_CLK from the delayed-signal detector 130 with the clock signal CLK from the clock signal generator 110, and outputs a delay time DT of the pulse clock signal P_CLK relative to the clock signal CLK.

The contact position data generator 150 receives the delay time DT from the comparator 140, and outputs a coordinate corresponding to the delay time DT as contact position data TS_OUT of the object.

A method by which the touch sensor of FIG. 4 detects the contact position of the object will be described with reference to FIG. 3.

Here, it is assumed that the touch pad P1_2 of the touch pads P1_1 to P1_(n) connected in series is brought into contact with the object.

First, the clock signal generator 110 generates the clock signal CLK and outputs it to the touch pad P1_1 of the touch pattern via the clock output pin out and to the comparator 140 in the touch sensor 100.

The clock signal CLK input to the touch pattern is converted into the delayed clock signal D_CLK by the resistance of the plurality of touch pads P1_1 to P1_(n) and the plurality of connection lines CL1_1 to CL1_(n−1) and the capacitance of the object, and output via the last touch pad P1_(n).

The delayed-signal detector 130 receives the delayed clock signal D_CLK, which is obtained as the clock signal CLK is delayed and distorted by the plurality of touch pads P1_1 to P1_(n), via the clock input pin in, senses a level of the delayed clock signal D_CLK, and outputs a pulse clock signal P_CLK. Here, the delayed-signal detector 130 may include logic elements, such as an even number of inverters or buffers, or a comparator.

The comparator 140 compares the pulse clock signal P_CLK from the delayed-signal detector 130 and the clock signal CLK from the clock signal generator 110 to obtain a difference in delay time between the two signals, and outputs a delay time DT.

The contact position data generator 150 then receives the delay time DT from the comparator 140, obtains a coordinate corresponding to the delay time DT, and outputs the coordinate as the contact position data TS_OUT.

As described above, with the method for detecting a contact position according to the present invention, the contact position of the object can be detected by inputting the clock signal CLK to one terminal of the touch pattern on the ITO film 120, detecting the delay time DT of the signal delayed by the resistance of the touch pads P1_1 to P1_(n) and the plurality of connection lines CL1_1 to CL1_(n−1) in the touch pattern and the capacitance of the object, and obtaining the coordinate corresponding to the delay time DT. Thus, the contact position of the object can be sensed with only one touch pattern disposed on one entire surface of the ITO film 120, and one touch sensor.

However, in the method for detecting a contact position, since the touch sensor 100 outputs the clock signal CLK to one terminal of the touch pattern and receives the delayed clock signal D_CLK from the other terminal, an exact contact position of the object may not be detected when noise is generated. Since the noise is measured as a timing jitter, it may be removed by a noise removal filter or by calculating an average value for exact detection of the contact position. For example, the contact position data generator 150 may additionally include a digital filter such as an Infinite Impulse Response (IIR) filter for removing noise. Alternatively, the contact position data generator 150 may include average value storage unit for accumulating and storing average values to remove noise by adding or subtracting the accumulated average value to or from current calculated contact position data TS_OUT.

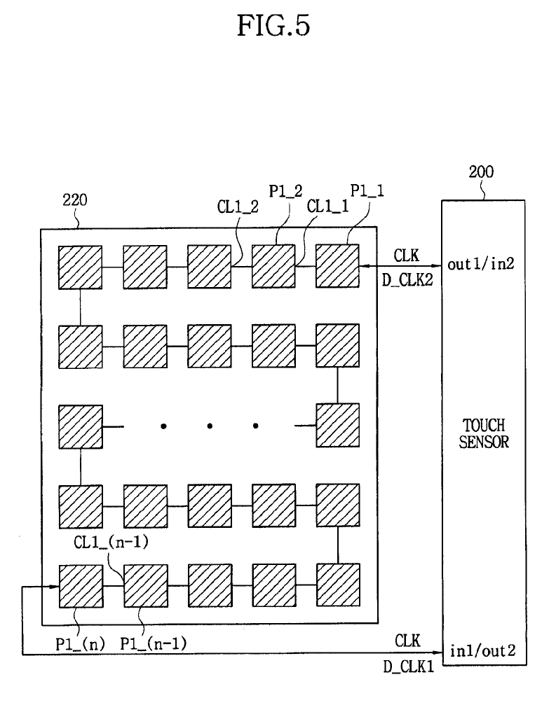

FIG. 5 illustrates a touch panel device according to a second exemplary embodiment of the present invention. In FIG. 5, a touch pattern formed on an ITO film 220 is the same as that of FIG. 3. The touch sensor 100 in FIG. 3 includes the clock output pin out and the clock input pin in to output the clock signal CLK to one terminal of the touch pattern and receive the delayed clock signal D_CLK from the other terminal, while the touch sensor unit 200 in FIG. 5 includes first and second clock input/output pins out1/in2 and in1/out2 to alternately output a clock signal CLK to both terminals of the touch pattern and receive delayed clock signals D_CLK1 and D_CLK2 from the terminals. That is, the touch sensor of FIG. 5 may alternatively apply the clock signal CLK to the same touch pattern, and alternatively receive the first and second delayed clock signals D_CLK1 and D_CLK2. It will be easily appreciated that the first clock input/output pin out1/in2 may be divided into a first input pin and a first output pin (not shown) and the second clock input/output pin in1/out2 may be divided into a second input pin and a second output pin (not shown) to output or receive the first and second delayed clock signals D_CLK1 and D_CLK2, instead of using the first and second clock input/output pins out1/in2 and in1/out2 to input/output the clock signal CLK. Although the connection lines CL1_1 to CL1_(n−1) are separate from the touch pads P1_1 to P1_(n), it will be easily appreciated that the connection lines and the touch pads may be formed in one continuous structure, such as a single bar.

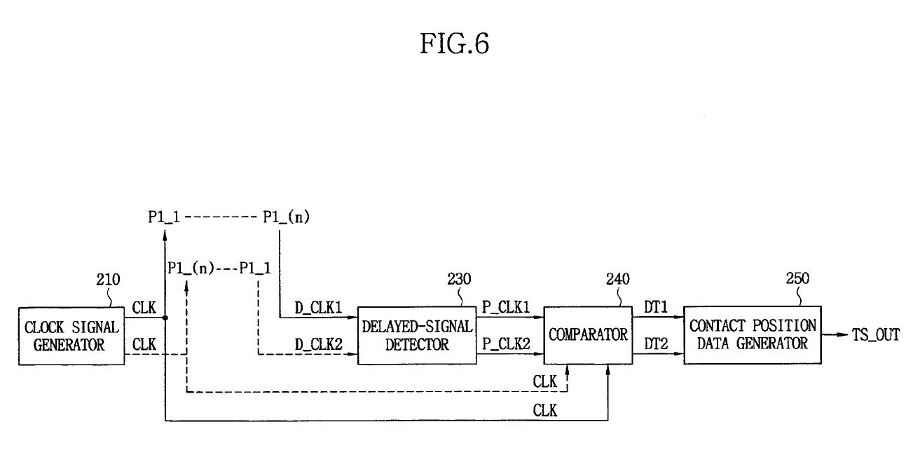

FIG. 6 is a block diagram for explaining a configuration of the touch sensor in FIG. 5 and a method for detecting a contact position. In FIG. 6, the touch sensor comprises a clock signal generator 210, a delayed-signal detector 230, a comparator 240, and a contact position data generator 250, like the touch sensor of FIG. 3. First, a configuration of the touch sensor in FIG. 6 will be described with reference to FIG. 5.

The clock signal generator 210 generates a clock signal CLK and alternately outputs it to the first touch pad P1_1 or the last touch pad P1_(n) of the touch pattern via the clock input/output pins out1/in2 and in1/out2 and to the comparator 240 in the touch sensor unit 200. The delayed-signal detector 230 receives the second delayed clock signal D_CLK2 from the first touch pad P1_1 via the clock input/output pin out1/in2, or the first delayed clock signal D_CLK1 from the last touch pad P1_(n) via the clock input/output pin in1/out2.

The delayed-signal detector 230 receives the first and second delayed clock signals D_CLK1 and D_CLK2 via the touch pattern, senses levels of the first and second delayed clock signals D_CLK1 and D_CLK2, and generates and outputs first and second pulse clock signals P_CLK1 and P_CLK2.

The comparator 240 compares the first and second pulse clock signals P_CLK1 and P_CLK2 from the delayed-signal detector 230 with the clock signal CLK from the clock signal generator 210, measures delay times of the first and second pulse clock signals P_CLK1 and P_CLK2 relative to the clock signal CLK, and outputs first and second delay times DT1 and DT2.

The contact position data generator 250 receives the first and second delay times DT1 and DT2 from the comparator 240 and outputs coordinates corresponding to the first and second delay times DT1 and DT2 as contact position data TS_OUT of the object.

A method by which the touch sensor of FIG. 6 detects a contact position of the object will be described with reference to FIG. 5.

It is assumed that one touch pad P1_2 of the touch pads P1_1 to P1_(n) connected in series is brought into contact with the object.

First, the clock signal generator 210 generates the clock signal CLK and outputs it to the first touch pad P1_1 of the touch pattern and the comparator 240 via the first clock input/output pin out1/in2.

The clock signal CLK input to the touch pattern is delayed and distorted by resistance of the plurality of touch pads P1_1 to P1_(n) and the plurality of connection lines CL1_1 to CL1_(n−1) and capacitance of the object brought into contact with the touch pad P1_2, and a first delayed clock signal D_CLK1 is output via the last touch pad P1_(n).

The delayed-signal detector 230 senses a level of the first delayed clock signal D_CLK1 and outputs a first pulse clock signal P_CLK1.

The comparator 240 compares the first pulse clock signal P_CLK1 from the delayed-signal detector 230 with the clock signal CLK from the clock signal generator 210, measures the delay time of the first pulse clock signal P_CLK1 relative to the clock signal CLK, and outputs the first delay time DT1.

The contact position data generator 250 receives the first delay time DT1 from the comparator 240 and stores it.

The clock signal generator 210 then outputs the generated clock signal CLK to the last touch pad P1_(n) of the touch pattern and the comparator 240 via the second clock input/output pin in1/out2.

The clock signal CLK input to the touch pattern is delayed and distorted by the resistance of the plurality of touch pads P1_1 to P1_(n) and the plurality of connection lines CL1_1 to CL1_(n−1) and the capacitance of the object brought into contact with the touch pad P1_2, and a second delayed clock signal D_CLK2 is output via the first touch pad P1_1.

The delayed-signal detector 230 senses a level of the second delayed clock signal D_CLK2 and outputs a second pulse clock signal P_CLK2.

The comparator 240 compares the second pulse clock signal P_CLK2 from the delayed-signal detector 230 with the clock signal CLK from the clock signal generator 210, measures a delay time of the second pulse clock signal P_CLK2 relative to the clock signal CLK, and outputs a second delay time DT2.

The contact position data generator 250 receives the delay time DT2 from the comparator 240, compares the first stored delay time DT1 with the second input delay time DT2 to obtain a corresponding coordinate, and outputs the coordinate as the contact position data TS_OUT. Here, the contact position data generator 250 may calculate coordinates corresponding to the first and second delay times DT1 and DT2 and use an average of the two coordinates to obtain the contact position data TS_OUT. Also, the contact position data generator 250 calculates a difference between the first and second delay times DT1 and DT2 to obtain the contact position data TS_OUT directly.

As described above, the touch sensor of FIG. 6 alternatively outputs the clock signal CLK to both terminals of the touch pattern on the ITO film 220, and detects the delay time of the clock signal CLK twice, which is delayed by the resistance of the plurality of touch pads P1_1 to P1_(n) and the plurality of connection lines CL1_1 to CL1_(n−1) and the capacitance of the object brought into contact with the touch pads P1_1 to P1_(n). Since the two delay times DT1 and DT2 are used to obtain the coordinate, an exact contact position of the object can be obtained even when there is noise or offset capacitances between the ITO film 220 and a display panel.

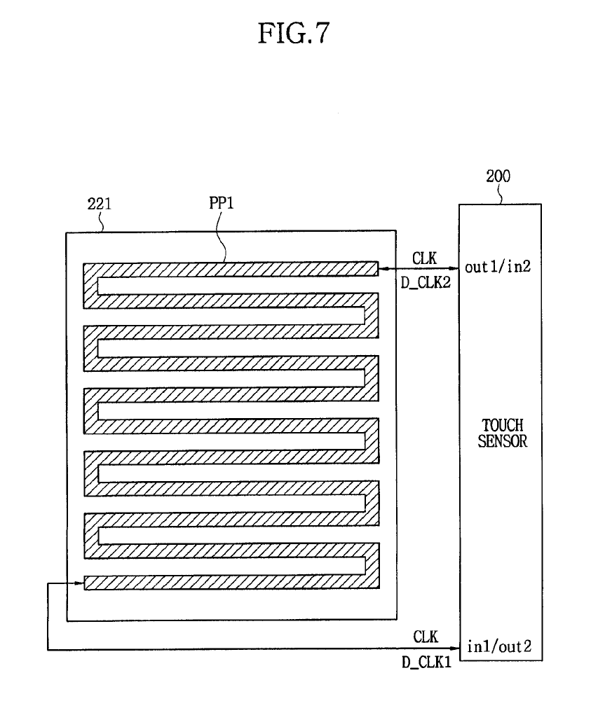

FIG. 7 illustrates a touch panel device according to a third exemplary embodiment of the present invention.

A touch sensor unit 200 in FIG. 7 is the same as that in FIG. 5. However, the touch pattern of FIG. 5 includes the plurality of serially connected touch pads P1_1 to P1_(n) and the plurality of serially connected connection lines CL1_1 to CL1_(n−1) while the ITO film 221 of FIG. 7 has a structure in which a plurality of touch pads in a horizontal direction and a plurality of touch pads in a vertical direction are connected in series directly without connection lines. That is, in the touch pattern PP1 of FIG. 7, the plurality of touch pads are directly connected in series and uniformly disposed on one surface of the ITO film 221. Although the invention has been described with respect to the plurality of touch pads, the touch pads disposed on the ITO film 221 constitute one rod. The shape of the touch pattern including only the touch pads without connection lines is not limited to the touch pattern PP1 shown in FIG. 7. In other words, the shape of the touch pattern may be implemented to have any of various shapes.

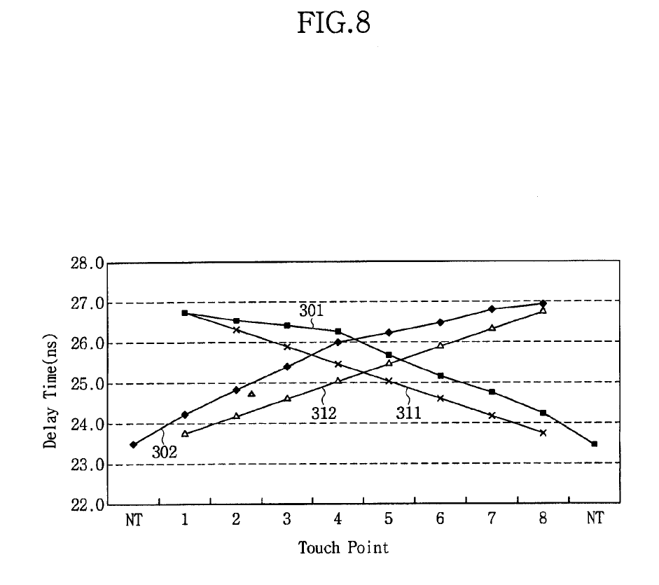

FIG. 8 is a graph showing a delay time depending on a contact position of an object obtained using the touch sensor of FIG. 6.

The graph of FIG. 8 will now be described with reference to FIG. 5.

In the graph of FIG. 8, the contact position (i.e., a touch point) of the object on an X-axis is for eight touch pads 1 to 8 connected in series in the touch pattern formed on the ITO film 220. When the object is brought into contact with each of the eight touch pads 1 to 8, the delay time of the clock signal CLK alternately applied to both terminals of the touch pattern is indicated on a Y-axis. Accordingly, two delay times are obtained for each of the eight contact positions 1 to 8 on the X-axis. For reference, a contact position NT on the X-axis indicates no touch.

In FIG. 8, a graph 301 showing a delay time measured when the clock signal CLK is applied to the first touch pad 1 of the touch pads 1 to 8 of the touch pattern and the object is sequentially brought into contact with the touch pads 1 to 8, a graph 302 showing a delay time measured when the clock signal CLK is applied to the last touch pad 8 of the touch pads 1 to 8 of the touch pattern and the object is sequentially brought into contact with the touch pads 1 to 8, and graphs 311 and 312 plotted using a computer simulation program with the same settings as in the two graphs 301 and 302 are shown. The graph 311 is a simulation corresponding to the graph 301 and the graph 312 is a simulation corresponding to the graph 302. The differences between measured values (301 and 302) and simulation values (311 and 312) are mainly caused by external noises and the offset capacitances.

A method by which the contact position data generator of FIG. 6 detects the contact position of the object will now be described with reference to FIG. 8.

Here, since the touch sensor unit 200 of the present invention alternately outputs the clock signal CLK to the touch pads 1 and 8 disposed at both terminals of the touch pattern as described in FIG. 6, two delay times DT1 and DT2 are detected via the touch pads 1 to 8 and used.

First, a method for detecting a contact position using a difference between the two detected delay times will be described in greater detail.

For example, when the object is brought into contact with one of the touch pads 1 to 8, the first delay time DT1 is measured to be 26.5 ns and the second delay time DT2 is measured to be 24.8 ns, the touch sensor unit 200 may calculate a difference between the first delay time DT1 and the second delay time DT2 and obtain the position of the touch pad corresponding to the calculated delay time difference of 1.7 ns. In the graph of FIG. 8, the object is brought into contact with the second touch pad 2. The touch sensor unit 200 then outputs the contact position data TS_OUT of the object corresponding to the second touch pad 2 using the set contact position data TS_OUT of the object corresponding to the touch pads 1 to 8. Thus, since the contact position data TS_OUT of the object corresponding to the delay times is set, the touch sensor unit 200 can directly output the contact position data TS_OUT of the object corresponding to the calculated delay time of 1.7 ns.

Here, the difference between the first delay time DT1 and the second delay time DT2 becomes 0 at the central touch pad of the touch pattern, and has a reversed sign on the touch pads located at both sides of the central touch pad. In the graph of FIG. 8, the calculated delay time differences of the touch pads 1 to 8 are values between about −3 ns and about 3 ns.

The use of the difference in delay time can reduce influence of noise because an offset of the delay time is automatically removed.

Second, a method for detecting the contact position using a ratio of the two detected delay times will be described.

For example, when the object is brought into contact with the touch pads 1 to 8 connected in series, the first delay time DT1 is measured to be 27 ns and the second delay time DT2 is measured to be 24 ns, the touch sensor unit 200 calculates a ratio of the first delay time DT1 and the second delay time DT2, as indicated in Expression 1.

DT1/DT2×100 Expression 1

The calculated delay time is 112.5. The position of the touch pad corresponding to 112.5 can be obtained. In the graph of FIG. 8, the object is bought into contact with the first touch pad 1. In this case, the touch sensor 100 may set a contact position data TS_OUT of an object corresponding to a ratio of the calculated delay time, and directly output a contact position data TS_OUT of the object corresponding to the calculated delay time ratio of 112.5. The touch sensor 100 then outputs a contact position data TS_OUT of an object corresponding to the first touch pad 1 using the set contact position data TS_OUT of an object corresponding to the touch pads 1 to 8.

Here, the ratio of the first delay time and the second delay time becomes 1 (100 in Expression 1) at the central touch pad of the touch pads 1 to 8, and the first touch pad 1 to the eighth touch pad 8 have delay time ratios in descending order. In the graph of FIG. 8, the calculated delay time ratio of the touch pad becomes a value between about 113 and about 89.

The use of the delay time ratio increases the calculated delay time value, such that the contact position TS_OUT of the object can be obtained more accurately.

In the touch pattern of the present invention, the plurality of touch pads differ in size from the plurality of connection lines to detect the contact position using the predetermined unit regions. Thus, the contact position can be exactly sensed even when the difference between or the ratio of the delay times is used as described above. Although subtraction and ratio of the first delay time and the second delay time are used as examples for simplicity, it is natural to use combination of subtraction and ratio or other mathematic methods (not limited but, such as a logarithmic operation).

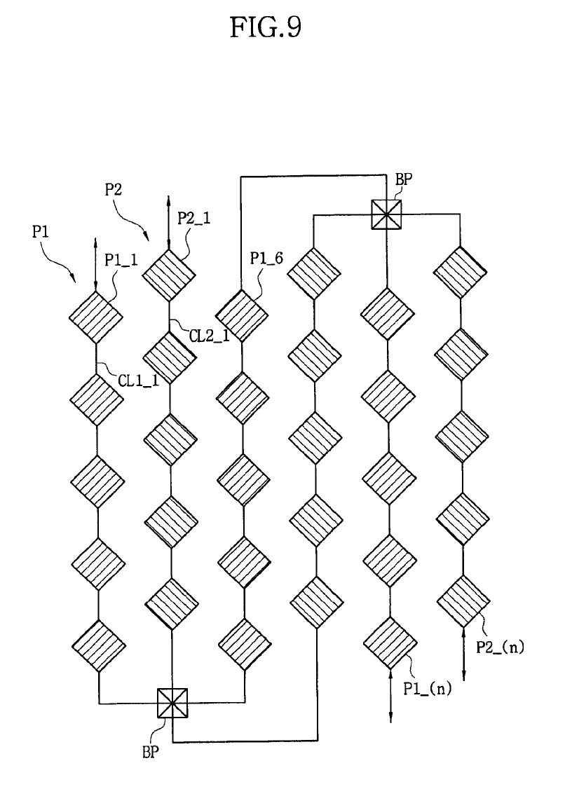

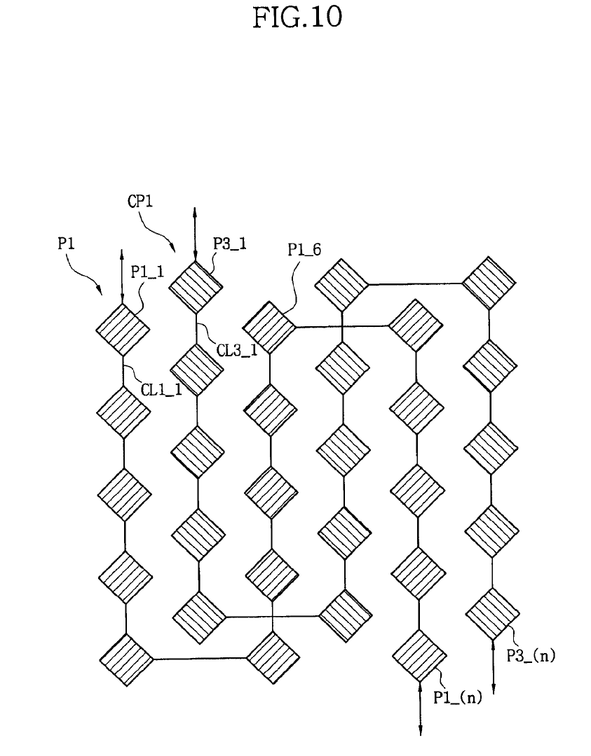

FIGS. 9 and 10 illustrate a touch pattern disposed on an ITO film according to another exemplary embodiment of the present invention.

In the touch patterns on the ITO film 120 or 220 shown in FIG. 3 or 5, a narrower spacing between the touch pads can increase the resolution of the touch panel, but a contact of two or more of the plurality of touch pads P1_1 to P1_(n) with the object may cause erroneous contact position data TS_OUT. Therefore, it is desirable that the plurality of touch pads P1_1 to P1_(n) have a sufficient spacing so that two or more touch pads are not simultaneously brought into contact with the object. The ITO film 120 or 220 shown in FIG. 3 or 5 having one touch pattern cannot increase the resolution of the touch panel.

FIG. 9 illustrates two pattern lines P1 and P2 disposed side by side on the same surface of one ITO film 120 or 220.

Since the first and second touch patterns P1 and P2 are disposed side by side, a plurality of touch pads in the first and second touch patterns P1 and P2 have sufficient spacing to prevent a plurality of touch pads P1_1 to P1_(n) in the first touch pattern P1 or a plurality of touch pads P2_1 to P2_(n) in the second touch pattern from being simultaneously brought into contact with an object. When the two touch patterns P1 and P2 are disposed side by side, connection lines CL1_1 to CL1_(n−1) of the first touch pattern P1 and connection lines CL2_1 to CL2_(n−1) of the second touch pattern P2 are insulated from each other so that crossing points BP of the two connection lines are not short-circuited. Also, a minimized spacing between the first touch pattern P1 and the second touch pattern P2 can increase the resolution of the touch panel. Although only the two touch patterns P1 and P2 are shown in FIG. 9, it can be easily appreciated that more touch patterns may be included.

Thus, in FIG. 9, the plurality of touch pads of the same touch pattern can be prevented from being simultaneously brought into contact with the object, and high resolution can be obtained by using a plurality of touch patterns.

Here, the crossing points BP of CL1_1 to CL1_(n−1) and CL2_1 to CL2_(n−1) may be insulated within the ITO film 120 or 220. However, it will be easily appreciated that the connection lines CL may be disposed and insulated outside the ITO film 120 or 220. Even when the connection lines CL are insulated within the ITO film 120 or 220, the insulation should not affect the display. In general, the ITO film 120 or 220 is larger than a video display area of the display device. Accordingly, the insulation outside the ITO films 120 and 220 does not affect the display.

In FIG. 10, two touch patterns are disposed one by one on both surfaces of the ITO film 120 or 220. Among the touch sensors, a capacitance sensing-type touch sensor that detects the contact of the object by detecting a change in capacitance is structurally similar to a capacitance sensing-type proximity sensor. That is, the capacitance sensing-type touch sensor can be used as a proximity sensor by setting the sensitivity of the capacitance sensing-type touch sensor to a high level. Accordingly, although the object is not directly contact with the touch sensor, the capacitance sensing-type touch sensor can detect the contact of the object. In FIG. 10, a first touch pattern P1 and a third touch pattern P3 are disposed on different surfaces of the ITO film 120 or 220. That is, the first touch pattern P1 is disposed on an upper surface of the ITO film 120 or 220, and the third touch pattern P3 is disposed on a lower surface of the ITO film 120 or 220. When the two touch patterns P1 and P3 are disposed on the different surfaces of the ITO film as described above, there are no crossing points BP as in FIG. 9 and no insulation is needed. Similarly, it will be easily appreciated that each of a plurality of ITO films may include one touch pattern. For a very high resolution touch panel, the structures of FIGS. 9 and 10 may be applied together. That is, a plurality of touch patterns may be disposed and used on one or both surfaces of at least one ITO film.

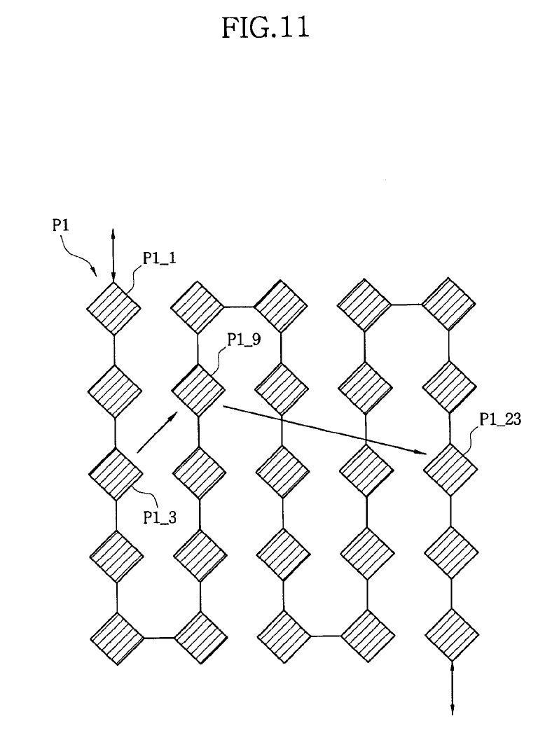

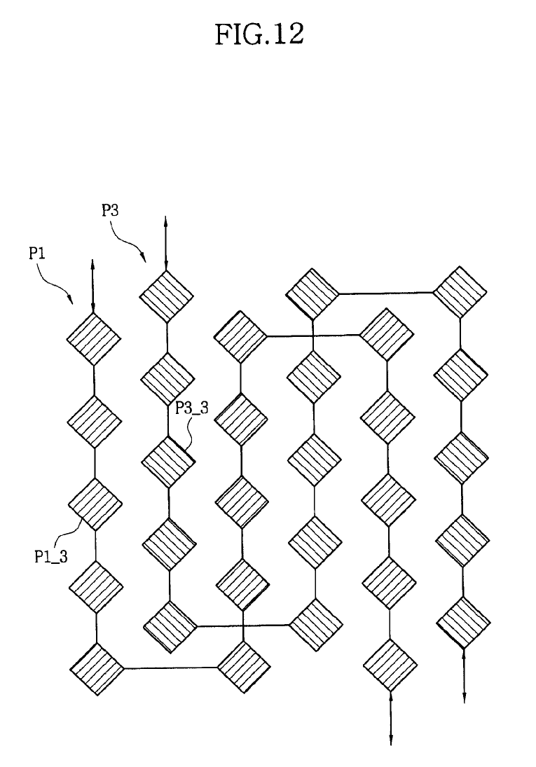

FIGS. 11 and 12 are diagrams for explaining interpolation in the touch panel device according to the present invention.

In general, the touch panel is attached to an external screen for a display, which displays a video signal on a screen, or formed on an external glass plate of the display. However, since the touch panel differs in resolution from the display, the contact position from the touch panel needs to correspond (be translated) to a corresponding position on the display screen. In this case, interpolation is used to correspond the position of the touch panel to the position of the display screen in order to represent a change in contact position more smoothly.

FIG. 11 illustrates interpolation in a time domain.

It is assumed that an object is sequentially brought into contact with a third touch pad P1_3, a ninth touch pad P1_9, and a 23rd touch pad P1_23 of touch pads P1 connected in series. Positions corresponding to positions of the respective touch pads P1_3, P1_9, and P1_23 are sequentially and discontinuously displayed on a display screen. Finally, only the position corresponding to the 23rd touch pad P1_23 will be displayed.

On the other hand, there may be a case in which the contact positions are represented continuously rather than discontinuously according to the purpose of use of a device comprising the touch panel. For example, in the case of a pointer for a computer, a movement path of a contact position must be continuously displayed. In this case, positions between the touch pads on the display screen, not on the ITO film 120, such as a position between the third touch pad P1_3 and the ninth touch pad P1_9 and a position between the ninth touch pad P1_9 and the 23rd touch pad P1_23, are divided over time to generate positions between the respective touch pads on the display screen and output it as an interpolation signal. That is, when the object is brought into contact with the touch pad P1_3 and then with the touch pad P1_9, the pointer does not indicate the position of the touch pad P1_9 directly after indicating the position of the touch pad P1_3, but indicates sequential movement over time from the position of the touch pad P1_3 to the position of the touch pad P1_9.

FIG. 12 illustrates interpolation in a spatial domain.

When the third touch pad P1_3 of the first touch pattern P1 and the third touch pad P3_3 of the second touch pattern P3 on the ITO film 120 or 220 in which the first touch pattern PL1 and the third touch pattern P3 are disposed side by side are simultaneously brought into contact with the object, a central position between the contact position calculated using the first touch pattern P1 and the contact position calculated using the third touch pattern P3 is output as the contact position data TS_OUT of the object. Although the present invention has been described with respect to the touch pattern shown in FIG. 10, it will be easily appreciated that the interpolation in the spatial domain can be performed even with the touch pattern shown in FIG. 9.

Additionally, the interpolation describe above uses an interpolation signal output unit (not shown) for receiving the contact position data TS_OUT of the object from the touch sensor of FIG. 3 or 5 and interpolating and outputting it to output the interpolation signal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A touch panel device comprising:
a touch panel including a first touch pattern, the first touch pattern having a plurality of first touch pads connected in series; and
a touch sensor for applying a clock signal to one terminal of the first touch pattern, receiving a first delayed clock signal from the other terminal of the first touch pattern, and generating contact position data corresponding to a contact position of an object using a difference in delay time between the clock signal and the first delayed clock signal.

2. The device of claim 1, wherein the touch sensor comprises:
a clock generator for generating the clock signal and outputting it to one terminal of the first touch pattern;
a delayed-signal detector for sensing a level of the first delayed clock signal from the other terminal of the first touch pattern and outputting a first pulse clock signal;
a comparator for calculating the difference in delay time between the clock signal and the first pulse clock signal and outputting a first delay time; and
a contact position data generator for calculating a contact position corresponding to the first delay time and outputting the contact position data.

3. The device of claim 2, wherein the contact position data generator further comprises a noise remover for preventing the contact position data from being erroneously calculated due to noise.

4. The device of claim 3, wherein the noise remover comprises a digital filter.

5. The device of claim 3, wherein the noise remover comprises average value storage for storing accumulated average values of the contact position data and removing noise using the accumulated average values.

6. The device of claim 1, wherein the touch sensor applies the clock signal to the other terminal of the first touch pattern, receives a second delayed clock signal from one terminal of the first touch pattern, and generates the contact position data corresponding to the contact position of the object using the difference in delay time between the clock signal and each of the first and second delayed clock signals.

7. The device of claim 6, wherein the touch sensor comprises:
a clock generator for generating the clock signal and alternately outputting it to one terminal and the other terminal of the first touch pattern;
a delayed-signal detector for sensing a level of the first delayed clock signal output from the other terminal of the first touch pattern as the clock signal is delayed and a level of the second delayed clock signal output from one terminal of the first touch pattern, and outputting the first and second pulse clock signals;
a comparator for calculating a difference in delay time between the clock signal and the first pulse clock signal and outputting a first delay time, and calculating a difference in delay time between the clock signal and the second pulse clock signal and outputting a second delay time; and
a contact position data generator for calculating contact positions corresponding to the first and second delay times and outputting the contact position data.

8. The device of claim 7, wherein the contact position data generator generates the contact position data using a difference between the first and second delay times.

9. The device of claim 7, wherein the contact position data generator generates the contact position data using a ratio of the first and second delay times.

10. The device of claim 7, wherein the contact position data generator calculates a first contact position corresponding to the first delay time and a second contact position corresponding to the second delay time, obtains a central position between the calculated contact positions, and generates a contact position data corresponding to the central position.

11. The device of claim 1, wherein the touch panel comprises a first ITO film, in which the plurality of first touch pads of the first touch pattern are uniformly distributed on one entire surface of the first ITO film.

12. The device of claim 10, wherein the first touch pattern further comprises a plurality of first connection lines disposed between the plurality of first touch pads for connecting the plurality of first touch pads in series, the first connection lines being formed by patterning a conductive material on a narrower area than that of each of the plurality of first touch pads.

13. The device of claim 12, wherein the touch panel is disposed so that ones of the plurality of first touch pads of the first touch pattern are not simultaneously brought into contact with an object.

14. The device of claim 13, wherein the touch panel further comprises at least a second touch pattern.

15. The device of claim 14, wherein at least the second touch pattern comprises a plurality of second touch pads each disposed between the plurality of first touch pads of the first touch pattern on the same surface of the first ITO film, and a plurality of second connection lines for connecting the plurality of second touch pads in series.

16. The device of claim 15, wherein the touch panel further comprises an insulating member for insulating the first and second touch patterns not to be short-circuited with each other at crossing points, and the insulating member is disposed in an edge area of the first ITO film or external to the first ITO film.

17. The device of claim 14, wherein at least the second touch pattern comprises a plurality of second touch pads uniformly distributed on the entire other surface of the first ITO film, and a plurality of second connection lines for connecting the plurality of second touch pads in series.

18. The device of claim 17, wherein the touch panel further comprises an insulating member for insulating the first and second touch patterns not to be short-circuited with each other at crossing points, and the insulating member is disposed in an edge area of the first ITO film or external to the first ITO film.

19. The device of claim 14, wherein the touch panel further comprises at least a second ITO film, and at least the second touch pattern including a plurality of second touch pads uniformly distributed on one entire surface of the at least second ITO film, and a plurality of second connection lines for connecting the plurality of second touch pads in series.

20. The device of claim 19, wherein the touch panel further comprises an insulating member for insulting the first and second touch patterns not to be short-circuited with each other at crossing points, and the insulating member is disposed in an edge area of the first and second ITO films or external to the first and second ITO films.

21. The device of claim 14, wherein the touch panel further comprises at least a second ITO film and at least the second touch pattern including a plurality of second touch pads uniformly distributed on the entire other surface of the second ITO film, and a plurality of second connection lines for connecting the plurality of second touch pads in series.

22. The device of claim 21, wherein the touch panel further comprises an insulating member for insulting the first and second touch patterns not to be short-circuited with each other at crossing points, and the insulating member is disposed in an edge area of the first and second ITO films or external to the first and second ITO films.

23. The device of any one of claims 14, wherein the touch sensor comprises:
a clock generator for generating the clock signal and outputting it to one terminal of the first and second touch patterns;
a delayed-signal detector for sensing levels of the first delayed clock signals output from the other terminal of the first and second touch patterns and outputting a first pulse clock signal;
a comparator for calculating the difference in delay time between the clock signal and each of the first pulse clock signals and outputting a plurality of first delay times; and
a contact position data generator for calculating contact positions corresponding to the plurality of first delay times and outputting the contact position data.

24. The device of claim 23, wherein the contact position data generator further comprises a noise remover for preventing the contact position data from being erroneously calculated due to noise.

25. The device of claim 24, wherein the noise remover comprises a digital filter.

26. The device of claim 24, wherein the noise remover comprises average value storage for storing accumulated average values of the contact position data and removing noise using the accumulated average values.

27. The device of any one of claims 14, wherein the touch sensor comprises:
a clock generator for generating the clock signal and alternately outputting it to one terminal and the other terminal of the first and second touch patterns;
a delayed-signal detector for sensing levels of the plurality of first delayed clock signals output from the other terminal of the first and second touch patterns and levels of the plurality of second delayed clock signals output from one terminal of the first and second touch patterns, and outputting a plurality of first and second pulse clock signals;
a comparator for calculating the difference in delay time between the clock signal and each of the plurality of first pulse clock signals and outputting a plurality of first delay times, and calculating the difference in delay time between the clock signal and each of the plurality of second pulse clock signals and outputting a plurality of second delay times; and
a contact position data generator for calculating a contact position corresponding to the plurality of first and second delay times and outputting the contact position data.

28. The device of claim 27, wherein the contact position data generator outputs the contact position data using a difference between each of the plurality of first delay times and each of the plurality of second delay times corresponding to the plurality of first delay times.

29. The device of claim 27, wherein the contact position data generator outputs the contact position data using a ratio of the plurality of first delay times and the plurality of second delay times corresponding to the plurality of first delay times.

30. The device of claim 27, wherein when a plurality of contact positions corresponding to a plurality of first and second delay times are calculated, the contact position data generator calculates a central position between the plurality of contact positions and outputs the contact position data corresponding to the central position.

31. The device of claim 27, wherein when the object is sequentially brought into contact with different touch patterns of the plurality of first to fifth touch pads, the touch sensor outputs contact position data corresponding to the touch pad with which the object is first brought into contact, and outputs at least a contact position data corresponding to a position between the first contacted touch pad and a subsequently contacted touch pad prior to outputting contact position data corresponding to the subsequently contacted touch pad.

32. A method for detecting a contact position on a touch panel device, the method comprising:
disposing a first touch pattern, the first touch pattern having a plurality of first touch pads connected in series; and
applying a clock signal to one terminal of the first touch pattern, receiving a first delayed clock signal from the other terminal of the first touch pattern, and generating contact position data corresponding to a contact position of an object using a difference in delay time between the clock signal and the first delayed clock signal.

33. The method of claim 32, wherein disposing a first touch pattern further comprises disposing a plurality of first connection lines in order to connect the plurality of first touch pads in series, the plurality of first connection lines being formed by patterning a conductive material in a narrower area than the plurality of first touch pads between the plurality of first touch pads.

34. The method of claim 33, wherein generating contact position data comprises:
generating the clock signal and outputting it to one terminal of the first touch pattern;
sensing a level of the first delayed clock signal output from the other terminal of the first touch pattern, and outputting a first pulse clock signal;
calculating a difference in delay time between the clock signal and the first pulse clock signal and outputting the first delay time; and
calculating a contact position corresponding to the first delay time and outputting the contact position data.

35. The method of claim 34, wherein outputting the contact position data further comprises removing noise.

36. The method of claim 32, further comprising, by the touch sensor:
generating the clock signal and alternately outputting it to one terminal or the other terminal of the first touch pattern;
sensing a level of a first delayed clock signal output from the other terminal of the first touch pattern as the clock signal is delay and a level of a second delayed clock signal output from one terminal of the first touch pattern, and outputting first and second pulse clock signals;
calculating a difference in delay time between the clock signal and the first pulse clock signal to output a first delay time, and calculating a difference in delay time between the clock signal and the second pulse clock signal to output a second delay time; and
calculating a contact position corresponding to the first and second delay times and outputting the contact position data.

37. The method of claim 36, wherein outputting the contact position data comprises generating the contact position data using a difference between or a ratio of the first and second delay times.

38. The method of claim 36, wherein outputting the contact position data comprises calculating a contact position corresponding to the first delay time and a contact position corresponding to the second delay time, and obtaining a central position between the calculated contact positions to generate the contact position data.
